(19) United States
(12) Patent Application Publication
(10) Pub. No.: US 2025/0078666 A1
(43) Pub. Date: Mar. 6, 2025

(54) CONFLICT MANAGEMENT SYSTEMS AND METHODS USING AIRSPACE PARTITIONS

(71) Applicant: General Dynamics Mission Systems, Inc., Fairfax, VA (US)

(72) Inventor: Daniel Andrés DUQUE, Fairfax, VA (US)

(73) Assignee: General Dynamics Mission Systems, Inc., Fairfax, VA (US)

(21) Appl. No.: 18/458,622

(22) Filed: Aug. 30, 2023

(51) Int. Cl. G08G 5/00; G08G 5/04

(52) U.S. Cl. CPC G08G 5/30; G08G 5/80

(57) ABSTRACT

Methods and systems are provided for managing potential conflicts between entities operating within a three-dimensional volume of navigable space, such as different aircraft operating within navigable airspace. One method involves obtaining usage information associated with a first entity, mapping the usage information to one or more partitions in a partitioned domain corresponding to the volume of navigable space that encompass an operating region for the first entity, and updating registered usage data associated with the one or more partitions to maintain an association between the one or more partitions and the first entity. The method detects a concurrent usage conflict associated with a first partition after updating the registered usage data based at least in part on a second association between the first partition and a second entity, and in response to detecting the concurrent usage conflict, updates conflict data to include an indication of the concurrent usage conflict.

### TECHNICAL FIELD OF THE INVENTION

The subject matter described herein relates generally to vehicle systems, and more particularly, embodiments of the subject matter relate to managing conflicts between different vehicles or entities, such as different aircraft attempting to concurrently utilize the same volume or region of airspace.

### BACKGROUND OF THE INVENTION

This section provides background information related to the present disclosure which is not necessarily prior art.

Air travel and air transport play vital roles in modern economies, supporting global business, tourism and economic growth. As a result, air traffic is robust in many developed regions and forecasted to increase with the proliferation of unmanned aerial vehicles (UAVs) and adoption of new technologies, such as, for example, Urban Air Mobility (UAM) vehicles, vertical-takeoff-and-landing (VTOL) aircraft, and the like. Moreover, in addition to commercial and private aviation and other civilian aircraft, airspace is also utilized by military and governmental sources. Accordingly, the potential density and variety of different potential concurrent airspace users poses risks of potential conflicts and corresponding management complexities due to the time-varying nature of usage in relation to the overall volume of airspace encompassing a range of altitudes across a swath of geographic locations.

Governmental bodies or regulatory organizations, such as the Federal Aviation Administration (FAA) in the United States, provide various air traffic services to facilitate safe and efficient air navigation, such as, for example, flight plan filing, air traffic control (ATC), and the like to help maintain minimum separation in space and time between different aircraft and avoid loss of separation or other incursions. However, some airspaces are uncontrolled, and various potential airspace uses may not comport with established procedures, civilian regulations or otherwise align with air traffic services. For example, flight plan filing may not encompass uses by UAMs, UAVs or military, or their usage may be unsuited for ATC or other services. Similarly, while systems such as Automatic Dependent Surveillance-Broadcast (ADS-B) or other collision avoidance systems are common on certain types of aircraft, they may not be present across all the different entities potentially using a common airspace. Additionally, existing services may be constrained or limited to homogenous data or types of entities or usages, such that they are unable to readily adapt to increasingly heterogenous airspace usage across different entities.

Accordingly, it is desirable to provide systems and methods for managing and mitigating potential airspace conflicts dynamically and in real-time while being capable of accommodating and adapting to different types of entities and airspace usages without increasing workload on air traffic controllers, pilots, or other human operators. Other desirable features and characteristics will become apparent from the subsequent detailed description and the appended claims, taken in conjunction with the accompanying drawings and the foregoing technical field and background.

### SUMMARY OF THE INVENTION

This section provides a general summary of the disclosure and is not a comprehensive disclosure of its full scope or all of its features.

Exemplary implementations described herein encompass systems, apparatuses and methods for monitoring for conflicts between different entities operating in a volume of navigable space, such as different aircraft, aerial vehicles, projectiles or other airborne entities within a volume of navigable airspace encompassing a common geographic area.

An exemplary implementation of a method of monitoring for conflicts between entities operating in a volume of navigable space involves obtaining, from a client over a network, usage information associated with a first entity, wherein the usage information is indicative of an operating region for the first entity, mapping the usage information to one or more partitions of a plurality of partitions corresponding to the volume of navigable space, wherein the one or more partitions encompass the operating region for the first entity, updating registered usage data associated with the one or more partitions to maintain an association between the one or more partitions and the first entity, detecting a concurrent usage conflict associated with a first partition of the one or more partitions after updating the registered usage data associated with the first partition based at least in part on a second association between the first partition and a second entity different from the first entity, and in response to detecting the concurrent usage conflict, updating conflict data to include an indication of the concurrent usage conflict associated with the first entity and the first partition.

In one or more exemplary implementations, a system is provided that includes a database to maintain registered airspace usage data and conflict data for a volume of navigable airspace and a conflict management server coupled to the database and a communications network to provide an airspace management service. The airspace management service is configurable to receive, from a client over the communications network, a reservation request comprising airspace usage information associated with a first entity, wherein the airspace usage information is indicative of an operating region for the first entity within the volume of navigable airspace, map the airspace usage information to one or more airspace partitions of a plurality of airspace partitions corresponding to the volume of navigable airspace, wherein the one or more airspace partitions encompass the operating region for the first entity, and update the registered airspace usage data associated with the one or more airspace partitions to maintain an association between the one or more airspace partitions and the first entity. The airspace management service detects a concurrent usage conflict associated with a first airspace partition of the one or more airspace partitions after updating the registered airspace usage data associated with the first airspace partition based at least in part on a second association between the first airspace partition and a second entity different from the first entity, and in response to detecting the concurrent usage conflict, the airspace management service updates the conflict data to include an indication of the concurrent usage conflict associated with the first entity and the first airspace partition.

Also provided is an apparatus for a non-transitory computer-readable medium having computer-executable instructions stored thereon that, when executed by a processing system, cause the processing system to obtain, from a client over a network, usage information associated with a first entity, wherein the usage information is indicative of an operating region for the first entity within a volume of navigable space, map the usage information to one or more partitions of a plurality of partitions corresponding to the volume of navigable space, wherein the one or more partitions encompass the operating region for the first entity, update registered usage data associated with the one or more partitions to maintain an association between the one or more partitions and the first entity, detect a concurrent usage conflict associated with a first partition of the one or more partitions after updating the registered usage data associated with the first partition based at least in part on a second association between the first partition and a second entity different from the first entity, and in response to detecting the concurrent usage conflict, update conflict data to include an indication of the concurrent usage conflict associated with the first entity and the first partition.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

The drawings described herein are for illustrative purposes only of selected embodiments and not all possible implementations, where corresponding reference numerals indicate corresponding parts throughout the several views of the drawings. The particular choice of drawings is not intended to limit the scope of the present disclosure.

FIG. 1 depicts a block diagram of an exemplary conflict management system suitable for monitoring for actual or potential concurrent usage conflicts between different entities in accordance with one or more exemplary implementations;

FIG. 2 depicts a block diagram of an exemplary airspace management service suitable for use in the conflict management system of FIG. 1 in accordance with one or more implementations;

FIGS. 3-4 depict an exemplary scenario of different aircraft moving within a partitioned airspace domain suitable for monitoring by an airspace management service in the conflict management system of FIG. 1 in accordance with one or more implementations;

FIG. 5 is a flow diagram of an exemplary airspace management process suitable for implementation by an airspace management service in the conflict management system of FIG. 1 in accordance with one or more implementations; and

FIG. 6 is a flow diagram of an exemplary airspace monitoring process suitable for implementation by an airspace management service in the conflict management system of FIG. 1 in accordance with one or more implementations.

### DETAILED DESCRIPTION

The following detailed description is merely exemplary in nature and is not intended to limit the subject matter of the application and uses thereof. Furthermore, there is no intention to be bound by any expressed or implied theory presented in the preceding technical field, background, summary, or the following detailed description.

Embodiments of the subject matter described herein generally pertain to systems and methods for detecting attempts or intents by different entities to concurrently operate at or within substantially the same region of airspace at substantially the same point in time and providing corresponding notification of such concurrent airspace usage conflicts in an agnostic manner that accommodates heterogeneous data sources and heterogenous usages by heterogeneous entities. As described in greater detail below, a volume of navigable airspace is subdivided into discrete, nonoverlapping, three-dimensional partitions that collectively span the volume of navigable airspace. For a given entity operating within that volume of navigable airspace, airspace usage information indicative of the region(s) within which the entity is currently operating, planning to operate, or is predicted to operate is obtained and mapped or otherwise converted from its initial coordinate system or other spatial reference domain into the partitioned airspace domain to identify the subset of airspace partitions corresponding to the current or future operation of the entity, that is, the respective airspace partitions that are collocated with or otherwise overlap the regions where the entity is expected to operate within. The current or expected airspace usage by different entities is analyzed within the partitioned airspace domain to detect or otherwise identify when two or more different entities are expected to concurrently operate within a common airspace partition, and provide corresponding include indicia of the concurrent usage conflict with respect to that particular partition.

By mapping heterogeneous airspace usage to a common partition domain, the subject matter described herein is not limited to a fixed set of procedural airspaces and is capable of dynamically analyzing time-varying airspace usage by heterogenous entities and predictively identifying potential conflicts substantially in real-time. In this regard, the subject matter described herein is not limited to a particular applications and may accommodate any environment where analysis of movement by different entities in three-dimensional space is desirable, including terrestrial, marine or subsurface environments. That said, for purposes of explanation, the subject matter may be described herein primarily in the context of aircraft or aviation applications, including, but not limited to civilian, commercial, or military applications in controlled or uncontrolled airspaces. Moreover, the subject matter described herein is not limited to aircraft and may be implemented in the context of any sort of entity capable of operating within navigable airspace, including projectiles, artillery, drones, UAMs, UAVs, helicopters, rotorcraft and/or the like.

As described in greater detail below, in exemplary implementations, an airspace management service is hosted or otherwise provided on a network and implemented as a representational state transfer (REST) web service (e.g., a RESTful web service, REST API(s), and/or the like) that supports any number of different clients seeking to reserve or otherwise register airspace usage, in addition to any number of different clients seeking to monitor, listen or otherwise subscribe to the airspace management service for conflict notification. A client submits or otherwise provides a registration request to the airspace management service that includes geospatial and temporal airspace usage information indicative of a current, planned or predicted operating region for an entity to reserve the corresponding airspace for that entity or otherwise register that entity's usage of the corresponding airspace. The airspace management service maps or otherwise converts the airspace usage information into corresponding airspace partitions within the partitioned airspace domain and then registers or otherwise records the airspace partitions reserved by the entity along with corresponding temporal information corresponding to the period of time during which the entity is expected to be operating within a respective airspace partition.

When the airspace management service identifies that more than one entity has reserved or registered usage for the same airspace partition at the same point in time (or for overlapping periods of time), the airspace management service determines a concurrent usage conflict exists with respect to that particular airspace partition where the usage by the different entities is expected to overlap in both space and time. In response to detecting a concurrent usage conflict, the airspace management service generates an airspace conflict summary report or otherwise updates airspace conflict data to include indicia of the concurrent usage conflict associated with the particular airspace partition and the particular entities involved in the conflict. The airspace management service utilizes the conflict information contained in the airspace conflict summary report or other airspace conflict data to analyze subscription to identify any clients subscribed for monitoring a particular airspace and/or entity involved in the conflict, and then automatically pushes or otherwise provides indication of the concurrent usage conflict to the subscribing client(s). In this manner, when the airspace management service determines that both a spatial conflict and a temporal conflict exists between two entities requesting the same airspace partition for overlapping periods of time, interested parties can be automatically notified substantially in real-time to enable at least one of the entities to initiate one or more remedial actions to mitigate the concurrent usage conflict.

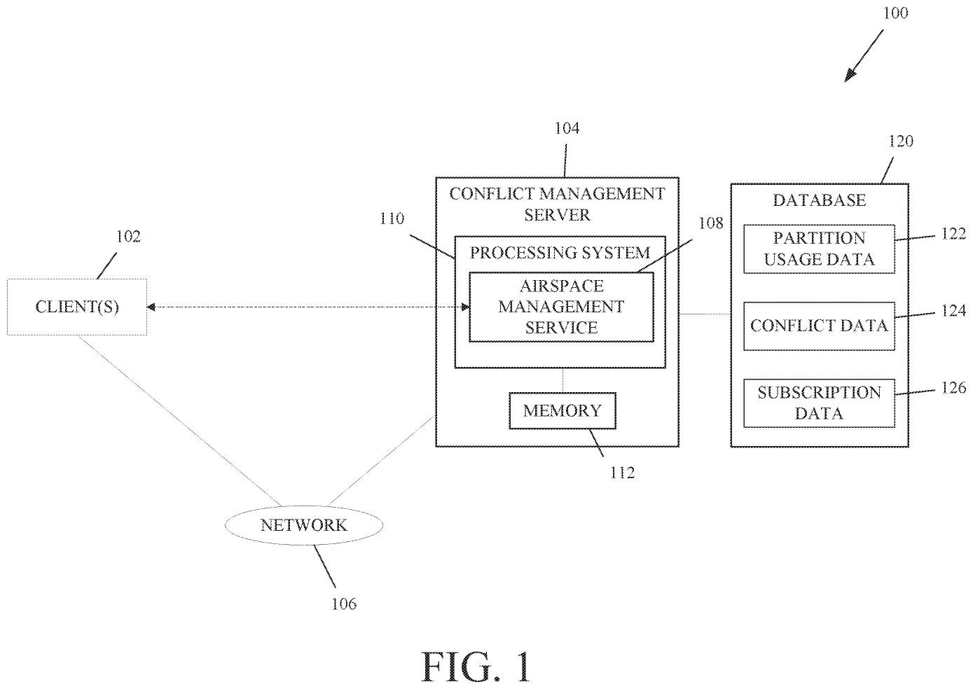

FIG. 1 depicts an exemplary conflict management system 100 suitable for detecting concurrent usage conflicts between different entities and providing corresponding indicia to any number of different clients 102. For purposes of explanation, the subject matter is described herein in the context of the entities being realized as an aircraft, aerial vehicle, or other vessel or body capable of traveling through navigable airspace in a predictable manner; however, the subject matter is not necessarily limited to airspace and may be implemented in an equivalent manner in the context of other types of vehicles, including ground-based vehicles, marine vessels, or the like.

The clients 102 generally represents electronic devices or other computing devices or systems that are capable of communicating with a conflict management server 104 over a communications network 106, such as, for example, the Internet, a computer network, a broadband network, a radio network, a cellular network, a wide area network, a local area network, a wireless local area network, a personal area network, or the like. In some implementations, one or more of the clients 102 may be realized as an avionics system or other device or component that is integrated or otherwise associated with an aircraft or other entity capable of traversing navigable airspace, such as, for example, a flight management system (FMS), a navigation system, an electronic flight bag (EFB) system, and/or the like. In other implementations, one or more of the clients 102 may be realized as any sort of personal computer, mobile telephone, tablet or other network-enabled electronic device. In exemplary implementations, the clients 102 include a graphical user interface (GUI) or display device, such as a monitor, screen, or another conventional electronic display, capable of graphically presenting data and/or information along with a user input device, such as a touchscreen, a touch panel, a mouse, a joystick, a directional pad, a motion sensor, or the like, capable of receiving input from the user of the client device. In one or more implementations, the clients 102 execute or otherwise support one or more client applications or services that support communications with an airspace management service 108 at the conflict management server 104 to submit reservation requests for airspace usage and/or subscribe for conflict notifications, as described in greater detail below.

The conflict management server 104 generally represents a server computing device, server computing system or another combination of processing logic, circuitry, hardware, and/or other components that are coupled to the communications network 106 and configurable to support the airspace management service 108 and related processes described herein. In this regard, the conflict management server 104 generally includes a processing system 110, which may be implemented using any suitable processing system and/or device, such as, for example, one or more processors, central processing units (CPUs), controllers, microprocessors, microcontrollers, processing cores and/or other hardware computing resources configured to support the operation of the processing system described herein. The processing system 110 may include or otherwise access a data storage element 112 (or memory) capable of storing programming instructions for execution by the processing system 110, that, when read and executed, are configurable cause processing system 110 to create, generate, or otherwise facilitate the airspace management service 108 based at least in part upon code and other data that is stored or otherwise maintained by the memory and support the subject matter described herein. The memory 112 may be realized as any sort of non-transitory short or long term storage media capable of storing programming instructions for execution by the processing system 110, such as, for example, random-access memory (RAM) memory, read-only memory (ROM) memory, flash memory, registers, a hard disk, or another suitable data storage medium known in the art or any suitable combination thereof.

In exemplary implementations, the conflict management server 104 is communicatively coupled to one or more databases 120 configurable to maintain airspace partition usage data 122, conflict data 124 and conflict subscription data 126 in connection with the airspace management service 108. As described in greater detail below, the airspace management service 108 receives or otherwise obtains from a client 102, on behalf of an aircraft or other entity seeking to utilize or reserve airspace, usage information indicative of the operating region where that aircraft or entity is currently operating or planning to operate, or is predicted or expected to operate, along with temporal information identifying the corresponding times or time periods associated with the requested usage of the operating region (or respective portions of the operating region). For example, an FMS or other client 102 associated with an aircraft may transmit, upload or otherwise provide a flight plan to the airspace management service 108 that includes a sequence of waypoints or other navigational reference points that the aircraft is planning to traverse along a route along with corresponding arrival times for the respective points along the route. As another example, a client 102 may transmit, upload or otherwise provide information identifying a current geographic location associated with a particular entity (e.g., latitude and longitude coordinates from a global navigation satellite system (GNSS) or global positioning system (GPS) associated with an aircraft) along with information identifying the current altitude, heading, velocity, vertical speed and/or other data characterizing the current state of the entity, from which the current and predicted operating region(s) for the entity can be derived. In this regard, the geospatial and temporal usage information provided by the clients 102 may be in any number of different initial or native formats associated with the respective entity or client 102 that are supported by the airspace management service 108 and is not necessarily constrained to a particular type or format of usage information accompanying a reservation request.

As described in greater detail below, the airspace management service 108 maps or otherwise converts the usage information accompanying a reservation request into corresponding airspace partitions within a partitioned airspace domain and stores or otherwise maintains data or other information identifying those airspace partitions associated with the particular entity as partition usage data 122 in the database 120. In this manner, the partition usage data 122 in the database 120 is utilized by the airspace management service 108 to track which entities are using which airspace partitions at which particular points in time to detect or otherwise identify concurrent airspace usage conflicts when two or more entities are likely to use the same or common airspace partition at or within an overlapping period of time. When a concurrent airspace usage conflict exists, the airspace management service 108 updates the conflict data 124 in the database 120 to include an entry corresponding to the conflict that maintains an association between the particular aircraft or entities associated with the respective conflict, the respective airspace partition where the respective conflict exists, and the respective time or time period associated with the respective conflict.

As described in greater detail below, in addition to airspace reservation requests, the airspace management service 108 also receives or otherwise obtains from a client 102, subscription information indicative of the particular aircraft, entities and/or operating regions that the respective client 102 would like to have monitored for concurrent airspace usage conflicts. For example, airspace management service 108 receives or otherwise obtains from a client 102 conflict monitoring information indicative of the aircraft or other entity for which the client 102 would like to receive notifications when a conflict exists with respect to that particular aircraft or entity and/or the particular operating region(s) for which the client 102 would like to receive notifications when a conflict exists with respect to a particular operating region. In this regard, some clients 102 may subscribe to conflict notifications specific to a particular aircraft or entity, while other clients 102 may subscribe to conflict notification specific to a particular region or volume of airspace independent of the aircraft or entities operating within that airspace. For example, an FMS or other client 102 associated with an aircraft may subscribe for conflict notifications pertaining to operation of the ownship aircraft, while an air traffic controller or other user or system monitoring a region of airspace may subscribe to conflict notifications pertaining to that particular volume of airspace of interest. In response to receiving a subscription request from a client 102, the airspace management service 108 updates the subscription data 126 in the database 120 to include an entry maintaining an association between the particular client 102 associated with the subscription request and the particular aircraft, entity and/or airspace partitions for which the subscribing client 102 would like to receive notifications.

When the airspace management service 108 identifies a conflict in the conflict data 124 that matches or otherwise corresponds to a subscription in the subscription data 126, the airspace management service 108 uses an identifier or other information associated with the client 102 associated with that subscription to automatically push, transmit or otherwise provide a conflict notification to that subscribed client 102. In various implementations, the airspace management service 108 may utilize the information associated with the conflict in the conflict data 124 to populate the content of the notification or otherwise provide indicia of the particular aircraft or entities involved in the conflict, the particular airspace partition involved in the conflict, the particular time or time period associated with the conflict, and/or the like. In this regard, the conflict notification may include information to facilitate a pilot or other user associated with the subscribed client 102 initiating remedial action to mitigate the conflict based on the conflict information associated with the received conflict notification.

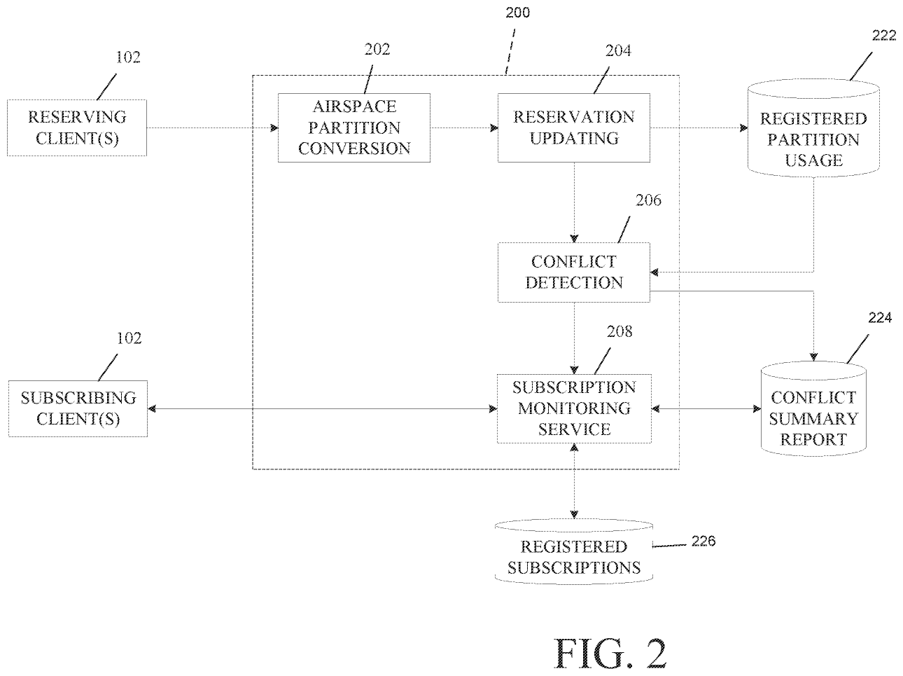

FIG. 2 depicts an exemplary implementation of an airspace management service 200 suitable for use as the airspace management service 108 in the conflict management system 100 of FIG. 1. The airspace management service 200 includes an airspace partition conversion service 202, which generally represents the software, logic or other components associated with the airspace management service 200 that is configurable to receive a reservation request and convert the received usage information associated with that reservation request from the initial reference coordinate system, domain or format that the geospatial usage information was provided in into corresponding airspace partitions within the partitioned airspace domain utilized by the airspace management service 200. In this regard, the airspace partition conversion service 202 converts a respective combination of a geographic location (e.g., latitude and longitude coordinates) and altitude indicative of the three-dimensional points or locations within navigational airspace where an aircraft or entity intends to operate into a corresponding partitioned volume of airspace that encompasses that particular combination of geographic location and altitude.

In one exemplary implementation, a volume of airspace is subdivided into a plurality of substantially cubic partitions, where the lateral and longitudinal dimensions of the respective partition span 1/3600 of a decimal degree of latitude and longitude, respectively, with the vertical (or altitudinal) dimension of the respective partition spanning 1000 feet above sea level, where the airspace partition conversion service 202 maps or otherwise converts an input combination of latitude/longitude coordinates and altitude into a respective cubic partition of the volume of airspace that encompasses that combination of geographic location and altitude. In this regard, each partition may be assigned a unique identifier indicative of the respective volume of airspace encompassed by the partition in a manner that allows input geospatial information to be mapped to the particular partition identifier in a deterministic manner. In one or more implementations, the airspace partition conversion service 202 may convert input geographic location information from the geographic coordinate system to the partitioned airspace domain by multiplying the latitude/longitude coordinates by the number of partitions per degree of latitude/longitude in the partitioned airspace domain and dividing the input altitude by the vertical distance (or altitude) per partition in the partitioned airspace domain.

For example, given a reservation request with the input geographic coordinate locations of 39°30′ North and 110°50′10″ West and altitude of 2500 ft above sea level, the airspace partition conversion service 202 may first convert the coordinate locations to decimal format (e.g., 39.5 and −110.836111) before multiplying the result by the number of partitions per degree (e.g., 3600) to arrive at corresponding identifiers for the mapped partition location in the partitioned airspace domain. In this regard, in some implementations, the airspace partition conversion service 202 may shift or offset the decimal coordinate locations (e.g., by 90 degrees and 180 degrees respectively to arrive at 129.5 and 69.163889) to avoid negative partition identifiers before multiplying by the number of partitions per degree and rounding the result down to the nearest integer, resulting in latitudinal partition identifier of 466200 (e.g., 129.5*3600) and a longitudinal partition identifier of 248990 (e.g., 69.163889*3600). Similarly, the input altitude of 2500 is divided by the altitude or vertical dimension per partition of 1000, resulting in an altitudinal partition identifier. Accordingly, a reservation request for an input geospatial location of 39°30′ North and 110°50′10″ West at 2500 feet may be mapped to an airspace partition having the identifier 466200-248990-2. It should be appreciated that there are numerous different potential mapping or labeling schemes that can be employed for converting geospatial positions into respective airspace partitions from any particular type or format of geospatial positions (e.g., Military Grid Reference System (MGRS), Universal Transverse Mercator (UTM) zones and meters northing and casting. Global Area Reference System (GARS) cells, and/or the like), and the subject matter described here is not limited to any particular partitioning scheme or input data format.

Still referring to FIG. 2, in exemplary implementations, after mapping the geospatial usage information associated with a reservation request to corresponding airspace partitions, the airspace partition conversion service 202 provides the mapped airspace partition information along with the corresponding temporal usage information and aircraft or entity identifier to a reservation updating service 204, which generally represents the software, logic or other components associated with the airspace management service 200 that is configurable to update a registered partition usage database 222 (e.g., partition usage data 122 in database 120) to include indicia of the requesting aircraft or entity and the temporal information associated with the reservation in association with the mapped airspace partitions associated with the reservation. For example, continuing the above example, the reservation updating service 204 may utilize the mapped partition identifier of 466200-248990-2 to identify the corresponding entry for the 466200-248990-2 airspace partition within the database 222 and update the 466200-248990-2 airspace partition entry to include a unique identifier associated with the particular aircraft or entity reserving usage of that particular partition along with the temporal information identifying the time period associated with the particular aircraft or entity operating within that partition.

After updating the registered partition usage database 222, the reservation updating service 204 automatically provides a notification or other indication to a conflict detection service 206, which generally represents the software, logic or other components associated with the airspace management service 200 that is configurable to analyze the registered partition usage database 222 to identify concurrent usage conflicts. In this regard, the reservation updating service 204 may provide indication of the airspace partitions that were updated or reserved, with the conflict detection service 206 utilizing the information received from the reservation updating service 204 to analyze the entries associated with the updated airspace partitions in the registered partition usage database 222 to detect or otherwise identify when a respective airspace partition is subject to or otherwise exhibits a potential concurrent usage conflict. For example, the conflict detection service 206 may analyze the 466200-248990-2 airspace partition entry in the registered partition usage database 222 to verify or otherwise confirm that no other reservations on behalf of other aircraft or entities exist for that partition, and if another reservation exists, verify or otherwise confirm that the time periods associated with the different reservations for the same airspace partition do not overlap in time.

In exemplary implementations, when the conflict detection service 206 identifies a concurrent usage conflict for an airspace partition, the conflict detection service 206 automatically generates or otherwise updates a conflict summary report 224 (e.g., conflict data 124 in database 120) that includes an entry identifying the particular airspace partition where the concurrent usage conflict exists, the particular aircraft or entities associated with the conflict, the particular time period associated with the conflict, and potentially other information characterizing the conflict. Additionally, after detecting a concurrent usage conflict, the conflict detection service 206 automatically provides a notification or other indication to a subscription monitoring service 208 that one or more new conflicts have been identified and that the conflict summary report 224 has been correspondingly updated.

Still referring to FIG. 2 with reference to FIG. 1, the subscription monitoring service 208 generally represents the software, logic or other components associated with the airspace management service 200 that is configurable to receive subscription requests from one or more clients 102 and monitor for conflicts that match or otherwise correspond to previously received subscription requests. In this regard, in response to receiving a subscription request from a particular client 102, the subscription monitoring service 208 automatically creates a corresponding entry in a database or table of registered subscriptions 226 (e.g., subscription data 126 in database 120) that maintains an association between one or more identifiers or other identification information associated with the subscribing client 102 associated with a particular subscription and other subscription information identifying the particular aircraft or entity of interest, the particular operating regions or airspace of interest, the particular time periods of interest, and/or the like. In response to a notification from the conflict detection service 206, the subscription monitoring service 208 analyzes the new entries in the conflict summary report 224 to detect or otherwise identify when the conflict information associated with the particular conflict matches or otherwise corresponds to the subscription information associated with a particular subscription. In this regard, when an entry in the conflict summary report 224 matches subscription information associated with a particular one of the registered subscriptions 226, the subscription monitoring service 208 utilizes the identification information associated with the subscribing client 102 associated with that subscription to automatically push or otherwise provide a conflict notification to that subscribing client 102 over the network 106.

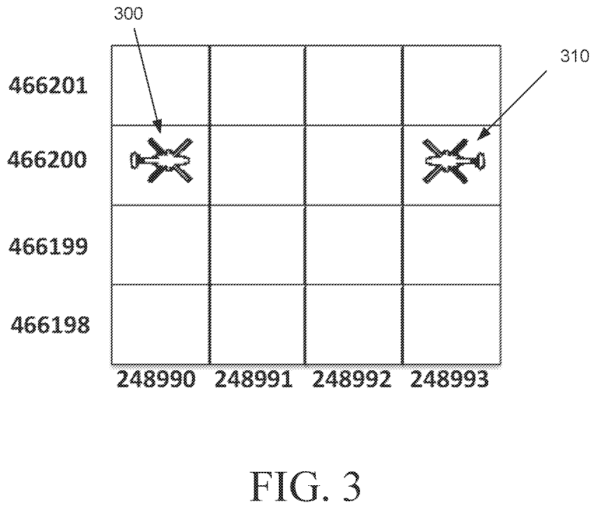

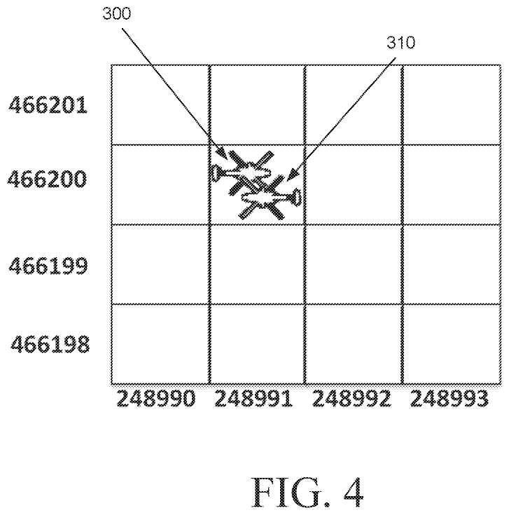

FIGS. 3 and 4 depict an exemplary scenario resulting from two aircraft operating within the same altitudinal or vertical range of partitions (e.g., 2000-3000 feet). Referring to FIG. 3, continuing the above example, a first aircraft 300 is operating at 39.5° North and 110.8361° West and traveling East at an altitude of 2500 ft above sea level, which maps to the airspace partition having the identifier 466200-248990-2, as described above. A second aircraft 310 is operating at 39.5° North and 110.835° West and traveling West at an altitude of 2200 ft above sea level, which maps to the airspace partition having the identifier 466200-248994-2. Accordingly, in response to the respective reservation requests associated with the aircraft 300, 310, the reservation updating service 204 of the airspace management service 108, 200 updates the registered airspace partition usage data 122, 222 such that the entry associated with the 466200-248990-2 airspace partition includes information identifying the first aircraft 300 and the time period associated with the expected presence of the first aircraft 300 within the partition (e.g., 00:00-00:30) and the entry associated with the 466200-248994-2 airspace partition includes information identifying the second aircraft 310 and the time period associated with the expected presence of the second aircraft 310 within the partition (e.g., 00:00-00:30).

After 25 seconds, the airspace management service 108, 200 receives an updated reservation request from a client 102 on behalf of the first aircraft 300 that maps to the 466200-248991-2 partition, which results in the reservation updating service 204 of the airspace management service 108, 200 updating the registered airspace partition usage data 122, 222 such that the entry associated with the 466200-248991-2 airspace partition includes information identifying the first aircraft 300 and the time period associated with the expected presence of the first aircraft 300 within the partition (e.g., 00:25-00:55). The reservation updating service 204 of the airspace management service 108, 200 may also update the registered airspace partition usage data 122, 222 to remove the reservation information associated with the first aircraft 300 from the entry associated with the previously occupied partition 466200-248990-2. As described above, the reservation updating service 204 may provide notification of the updated registered partition usage data 122, 222 to the conflict detection service 206, which, in turn, verifies a conflict associated with 466200-248991-2 airspace partition does not exist at that point in time.

Two seconds after the updated reservation request for the first aircraft 300, the airspace management service 108, 200 may receive an updated reservation request from a client 102 on behalf of the second aircraft 310 that maps to the 466200-248991-2 partition, which results in the reservation updating service 204 of the airspace management service 108, 200 updating the registered airspace partition usage data 122, 222 such that the entry associated with the 466200-248991-2 airspace partition includes information identifying the second aircraft 310 and the time period associated with the expected presence of the second aircraft 310 within the partition (e.g., 00:27-00:57). In response to the notification of the updated registered partition usage data 122, 222, the conflict detection service 206 determines that a spatial conflict exists with respect to the 466200-248991-2 airspace partition by virtue of multiple aircraft 300, 310 having reservation requests associated with that partition and then determines that a temporal conflict also exists by virtue of the time period associated with the second aircraft 310 overlapping the time period associated with the first aircraft 300. In response to detecting the concurrent usage conflict with respect to the 466200-248991-2 airspace partition, the conflict detection service 206 updates the conflict data 124, 224 to include a conflict reporting entry that includes the 466200-248991-2 airspace partition identifier, the unique identifiers associated with the respective aircraft 300, 310 involved in the conflict, and the time periods associated with the respective aircraft 300, 310 operating within that partition.

In response to a notification from the conflict detection service 206 of a new conflict, the subscription monitoring service 208 may query the subscription data 126, 226 using the identifier associated with the first aircraft 300 to identify any active subscriptions associated with the first aircraft 300. If any matching active subscriptions exist with respect to the first aircraft 300, the subscription monitoring service 208 utilizes the identification information for the subscribing client 102 to automatically push a conflict notification to the subscribing client 102 that includes information identifying the concurrent usage conflict. For example, the conflict notification may include information identifying the other aircraft 310 involved in the conflict, the time period associated with the conflict (e.g., the overlapping time period of usage from 00:27-00:55 for the partition) and/or information identifying the partition where the conflict exists (e.g., by converting the 466200-248991-2 airspace partition to a corresponding range of altitudes and locations in a geographic coordinate system). In a similar manner, the subscription monitoring service 208 may query the subscription data 126, 226 using the identifier associated with the second aircraft 310 to identify any active subscriptions associated with the second aircraft 310 and/or using the airspace partition identifier to identify any active subscriptions associated with the 466200-248991-2 airspace partition, and similarly provide conflict notifications to clients 102 subscribed to the second aircraft 310 and/or the 466200-248991-2 airspace partition.

It should be noted that FIGS. 3-4 depicts an example of the airspace management service 108, 200 that does not incorporate predictive reservations of airspace. In practice, the reservation requests received on behalf of the respective aircraft 300, 310 may include information identifying the current airspeed, vertical speed, heading and/or other information associated with the respective aircraft 300, 310 that may allow the airspace partition conversion service 202 to map the current trajectory of a respective aircraft 300, 310 to a sequence of airspace partitions that the respective aircraft 300, 310 is expected traverse or otherwise operate within a corresponding periods of time in the future. In such scenarios, where the reservation updating service 204 updates the registered airspace partition usage data 122, 222 to include information identifying both the current and predicted airspace usage associated with the respective aircraft 300, 310, the conflict detection service 206 may preemptively detect a concurrent usage conflict, for example, by determining the both aircraft 300, 310 are likely to be operating within the 466200-248991-2 airspace partition during the future time period of 00:27-0:55 and generating a corresponding conflict notification at time 00:00. In this manner, a user of subscribing client 102 associated with one of the aircraft 300, 310 (e.g., a pilot) or the 466200-248991-2 airspace partition (e.g., an air traffic controller) may proactively initiate remedial action to mitigate or otherwise alleviate the potential concurrent usage conflict, for example, by changing the trajectory of a respective one of the aircraft 300, 310, by changing the altitude or flight level of a respective one of the aircraft 300, 310, and/or the like.

It should be noted that although the subject matter may be described herein primarily in the context of substantially cubic partitions for purposes of explanation, in practice, the subject matter may be implemented using any sort of size or shape of partition, and the partitions need not be regular, symmetrical or otherwise identical to one another. For example, the volume of airspace encompassed by a respective substantially cubic partition may progressively increase at higher altitudes in an Earth-centered coordinate system or reference domain by virtue of the corresponding increase in the radius of the arcs defining the boundaries of the partitions even though the angle per partition may be fixed in the latitudinal and longitudinal dimensions (e.g., 1/3600°). In other words, the airspace partitions in the partitioned airspace domain may be irregular or nonuniform across the partitioned airspace domain, provided the mapping or conversion between the geospatial domain and the partitioned airspace domain consistently maps to the same geospatial position and vice versa in a deterministic manner.

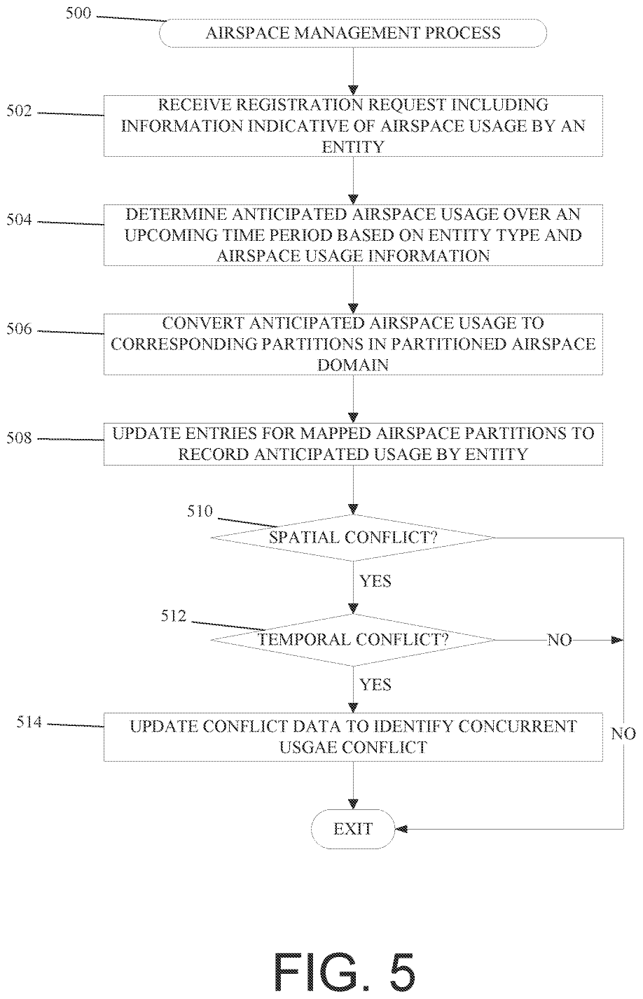

FIG. 5 depicts an exemplary airspace management process 500 suitable for use with any number of different clients and corresponding aircraft or other vehicles or entities operating within a common region of space. The various tasks performed in connection with the illustrated process may be implemented using hardware, firmware, software executed by processing circuitry, or any combination thereof. For illustrative purposes, the following description may refer to elements mentioned above in connection with FIGS. 1-4. Exemplary embodiments are described herein in the context of the airspace management process 500 being primarily implemented or performed by an airspace management service 108, 200 at a conflict management server 104 of a conflict management system 100. It should be appreciated that the airspace management process 500 may include any number of additional or alternative tasks, the tasks need not be performed in the illustrated order and/or the tasks may be performed concurrently, and/or the airspace management process 500 may be incorporated into a more comprehensive procedure or process having additional functionality not described in detail herein. Moreover, one or more of the tasks shown and described in the context of FIG. 5 could be omitted from a practical embodiment of the airspace management process 500 as long as the intended overall functionality remains intact.

Referring to FIG. 5, with continued reference to FIGS. 1-2, the illustrated airspace management process 500 initializes or otherwise begins by receiving or otherwise obtaining a registration request including information indicative of airspace usage by an entity at 502. As described above, a client 102 may transmit or otherwise provide a registration request on behalf of an aircraft or other vehicle or entity to an airspace management service 108, 200 over a network 106, where the registration request submitted on behalf of the entity includes geospatial and temporal information characterizing at least one of the current operating state of the entity and the future operating state of the entity. For example, in some implementations, an FMS or other client 102 associated with an aircraft may upload or otherwise submit a flight plan that includes a sequence of waypoints, geographic locations or other navigational reference points defining a trajectory the aircraft is planning to traverse along with corresponding altitudes and arrival times for when the aircraft is planning to be at particular locations along the route. In other implementations, an FMS or other system associated with an aircraft may transmit or otherwise provide indication of the current geographic location, the current altitude, the current heading, and/or other information characterizing the current operating state of the aircraft within a volume of airspace. In other implementations, a client 102 associated with an unmanned aerial vehicle, a projectile, or other entity may provide information identifying the range of geographic locations and corresponding altitudes where the entity is planning to operate. In this regard, the airspace management process 500 is not limited to any particular type or format of usage information that may accompany a reservation request.

In the illustrated implementation, the airspace management process 500 analyzes the usage information associated with the reservation request to identify or otherwise determine the anticipated airspace usage of the respective entity over an upcoming time period based at least in part on the particular entity type associated with the entity and the airspace usage information provided for the entity at 504. In this regard, depending on the particular type of entity associated with the reservation request and the usage information accompanying the request, the airspace management service 108, 200 may attempt to forecast or project where the entity is likely to be at particular points or periods of time into the future. For example, for a reservation request associated with an aircraft that includes a flight plan for the aircraft, the airspace management service 108, 200 may attempt to interpolate the flight plan to identify additional intermediary geographic locations and altitudes where the aircraft is likely to be at various points in time in the future. On the other hand, for a reservation request associated with a UAM, UAV or other vehicle that includes information identifying the current velocity, vertical speed or descent rate, heading and/or other real-time status information, the airspace management service 108, 200 may attempt to predict future locations of the entity assuming the current state is maintained over a limited prediction horizon (e.g., over the next thirty seconds, the next minute, and/or the like). It should be appreciated that the airspace management process 500 is similarly not limited to any particular manner, algorithm or scheme for forecasting or predicting future airspace usage for different types of entities.

The illustrated airspace management process 500 maps or otherwise converts the anticipated airspace usage for the particular aircraft, vehicle or other entity associated with the reservation request to corresponding overlapping or coincident airspace partitions in a partitioned airspace domain at 506 and correspondingly updates entries associated with those mapped airspace partitions to record information identifying the anticipated usage by the respective entity at 508. For example, after identifying the current and/or anticipated points in space where an aircraft, vehicle or other entity is likely to be at particular points in time, the airspace partition conversion service 202 of the airspace management service 108, 200 maps or otherwise converts the respective combinations of geographic locations and altitudes into discrete airspace partitions that are coincident with or otherwise encompass the respective combinations of geographic locations and altitudes. Once the airspace usage associated with a particular entity is mapped to the partitioned airspace domain, the reservation updating service 204 of the airspace management service 108, 200 updates the registered airspace partition usage data 122, 222 to maintain an association between the particular entity, the particular airspace partitions where the entity is currently operating or is expected to operate within, and the respective time periods when the entity is expected to be operating within the respective airspace partitions.

After updating the registered airspace partition usage data, the airspace management process 500 analyzes the registered airspace partition usage data to determine whether any spatial conflicts exist with respect to any airspace partitions at 510, and when a spatial conflict exists with respect to a particular partition, analyzes the temporal information associated with the respective usages of that airspace partition to determine whether a temporal conflict exists at 512. In this regard, as described above, a conflict detection service 206 associated with the airspace management service 108, 200 may analyze the recently updated entries in the registered airspace partition usage data 122, 222 to detect or otherwise identify a spatial conflict when two or more entities are associated with a particular airspace partition, that is, two or more entities have attempted to reserve the same airspace partition. When a spatial conflict is identified with respect to a particular airspace partition, the conflict detection service 206 further analyzes the time periods associated with the requested usage by the respective entities to detect or otherwise identify a temporal conflict when the time periods associated with two or more entities seeking to reserve the same partition overlaps in time.

When the airspace management process 500 verifies that no spatial and temporal conflicts exist, the airspace management process 500 may terminate or exit and reinitiate in response to receiving a subsequent registration request. On the other hand, when the airspace management process 500 identifies both a spatial conflict and a temporal conflict with respect to a particular airspace partition, the airspace management process 500 automatically updates conflict data to identify the concurrent usage conflict detected with respect to that particular airspace partition at 514. As described above, the conflict detection service 206 may generate a conflict summary report that includes conflict information identifying the conflicted airspace partition, the particular aircraft or entities involved or otherwise associated with the concurrent usage conflict, and the respective time periods associated with the respective aircraft or entities operation within that conflicted airspace partition. In this manner, the conflict data 124, 224 may maintain a listing of the different airspace partitions for which potential concurrent usage conflicts exist along with information identifying the particular entities involved in the respective conflicts and the respective time periods when the respective conflicts are expected to occur.

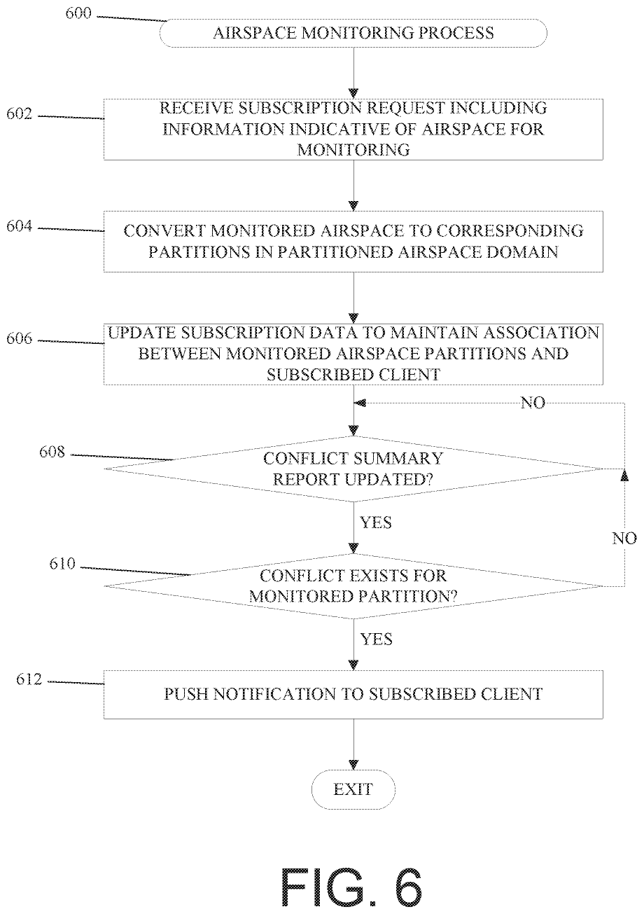

FIG. 6 depicts an exemplary airspace monitoring process 600 suitable for use with any number of different clients interested in monitoring a particular region of space for potential concurrent usage conflicts between different entities. The various tasks performed in connection with the illustrated process may be implemented using hardware, firmware, software executed by processing circuitry, or any combination thereof. For illustrative purposes, the following description may refer to elements mentioned above in connection with FIGS. 1-4. Exemplary embodiments are described herein in the context of the airspace monitoring process 600 being primarily implemented or performed by an airspace management service 108, 200 at a conflict management server 104 of a conflict management system 100. It should be appreciated that the airspace monitoring process 600 may include any number of additional or alternative tasks, the tasks need not be performed in the illustrated order and/or the tasks may be performed concurrently, and/or the airspace monitoring process 600 may be incorporated into a more comprehensive procedure or process having additional functionality not described in detail herein. Moreover, one or more of the tasks shown and described in the context of FIG. 6 could be omitted from a practical embodiment of the airspace monitoring process 600 as long as the intended overall functionality remains intact.

Referring to FIG. 6, with reference to FIGS. 1-4, the airspace monitoring process 600 initializes in response to receiving a subscription request from a client that includes information indicative of a desired region of airspace for monitoring at 602. In this regard, a client 102 associated with an air traffic controller or other user assigned with monitoring a particular region of airspace may transmit or otherwise provide a subscription request that includes information identifying the particular region of airspace of interest. For example, a client 102 may provide a subscription request that includes a center geographic coordinate location and radius along with minimum and maximum altitudes that define substantially cylindrical volume of airspace about an airport or other location of interest for monitoring. In yet other implementations, the client 102 may provide a subscription request that includes a name or other identifier associated with a controlled airspace or a procedural airspace that is predefined by a governmental or regulatory organization, where the airspace management service 108, 200 is capable of retrieving information defining the corresponding volume of airspace from a procedure database.

The illustrated implementation of the airspace monitoring process 600 maps or otherwise converts the airspace to be monitored to corresponding partitions in the partitioned airspace domain at 604 and then updates subscription data to maintain an association between those airspace partitions and the subscribed client at 606. For example, in a similar manner as described above, the combinations of geographic coordinate locations and altitudes defining the boundaries or extents of the region of airspace to be monitored may be converted to corresponding airspace partitions that define the boundaries or extents in the partitioned airspace domain, where airspace partitions that reside between those boundary airspace partitions may be automatically added or included in the list of airspace partitions to be monitored in connection with the subscription request. In this regard, the airspace management service 108, 200 identifies the range of airspace partitions that overlap or otherwise encompass the volume of airspace to be monitored. The resulting range of airspace partitions is stored or otherwise maintained in association with subscribing client 102 to receive conflict notifications for that airspace in the registered subscription data 126, 226 maintained by the airspace management service 108, 200.

For example, when the airspace is defined by a radius distance and a center coordinate location, the airspace management service 108, 200 may identify the corresponding minimum and maximum decimal latitudes for the airspace by projecting the radius distance from the center coordinate location at 90° and 270° and identify the corresponding minimum and maximum decimal longitudes for the airspace by projecting the radius distance from the center coordinate location at 0° and 180°. The airspace management service 108, 200 then converts the resulting minimum and maximum latitude and longitude coordinate locations into corresponding two-dimensional range of airspace partitions that define an geographic area of interest in the partitioned airspace domain. The airspace management service 108, 200 may then iteratively analyze each partition within the range of airspace partitions to exclude airspace partitions that do not intersect, overlap or otherwise coincide with at least a portion of the cylindrical airspace (e.g., based on a distance between a boundary of the partition and the center coordinate location being greater than the defined radius). After identifying the resulting set of airspace partitions corresponding to the two-dimensional range, the airspace management service 108, 200 may then identify the corresponding range of airspace partitions in the vertical or altitudinal dimension to encompass the entire three-dimensional volume of the airspace to be monitored in the partitioned airspace domain. The listing of airspace partitions defining that three-dimensional volume is then stored or otherwise maintained in association with an entry in the registered subscription data 126, 226 that includes a unique identifier or other information designating the subscribing client(s) 102 to receive conflict notifications with respect to that airspace.

Still referring to FIG. 6, the airspace monitoring process 600 maintains the subscription information associated with the subscription request until receiving indication that a conflict summary report has been updated at 608 and then analyzes the conflict summary report to determine whether a conflict exists for one or more partitions of the monitored airspace at 610. When a conflict exists with respect to one or more partitions of the monitored airspace, the airspace monitoring process 600 automatically generates or otherwise provides notification of the concurrent usage conflict to the subscribed client(s) associated with the particular subscription request for that airspace at 612. The subscribed client(s) 102 may then utilize the information contained in the concurrent usage conflict notification to initiate one or more remedial actions, such as, for example, adjusting one or more of a lateral trajectory, a vertical trajectory (e.g., an altitude or flight level), a speed or other characteristic of an aircraft or other entity to mitigate the potential conflict and prevent loss of separation.

As described above, in one or more exemplary implementations, a subscription monitoring service 208 receives a notification whenever a concurrent usage conflict is identified by a conflict detection service 206. In response to the notification, the subscription monitoring service 208 automatically analyzes the conflict data 124, 224 generated by the conflict detection service 206 to determine whether the conflict matches or otherwise corresponds to an existing subscription, that is, whether any clients 102 are subscribed to monitor for conflicts associated with the conflicted airspace partition. In one or more implementations, the subscription monitoring service 208 obtains conflict information from a new entry in a conflict summary report 224 identifying the airspace partition, the entity and/or the time period involved in the conflict and then queries the registered subscription data 126, 226 to determine whether the conflict information matches the subscription information for an existing subscription. When a conflicted airspace partition identified in the conflict summary report 224 matches a monitored airspace partition associated with an existing subscription in the registered subscription data 126, 226, the subscription monitoring service 208 uses the identification information for the client(s) 102 associated with that particular subscription to automatically push a notification of the conflict to the subscribed client(s) 102. In this manner, an air traffic controller or other user interested in monitoring a particular airspaces may be apprised of potential concurrent usage conflicts asynchronously and substantially in real-time as they are detected, thereby enabling initiation of remedial action to mitigate any potential conflicts and maintain separation between aircraft and other entities operating in nearby airspace.

By virtue of the subject matter described herein, navigable airspace may be continually analyzed for potential conflicts between different types of aircraft or entities, which may report their current and/or planned usage in any sort of format suitable for conversion to a partitioned airspace domain. Actual or potential concurrent usage conflicts can be detected substantially in real-time, and corresponding notifications can be pushed to any number of different clients subscribed for monitoring those conflicts, thereby allowing remedial actions to be initiated to mitigate conflicts and prevent loss of separation or other potential incursions.

For the sake of brevity, conventional techniques related to navigation, air traffic services, air traffic control, controlled airspaces, uncontrolled airspaces, geographic coordinate systems, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory storage medium known in the art. An exemplary storage medium is coupled to the processor such that the processor can read information from, and write information to, the storage medium. In the alternative, the storage medium may be integral to the processor. The processor and the storage medium may reside in an ASIC.

The subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of monitoring for conflicts between entities operating in a volume of navigable space, the method comprising:
obtaining, from a client over a network, usage information associated with a first entity, wherein the usage information is indicative of an operating region for the first entity;
mapping the usage information to one or more partitions of a plurality of partitions corresponding to the volume of navigable space, wherein the one or more partitions encompass the operating region for the first entity;
updating registered usage data associated with the one or more partitions to maintain an association between the one or more partitions and the first entity;
detecting a concurrent usage conflict associated with a first partition of the one or more partitions after updating the registered usage data associated with the first partition based at least in part on a second association between the first partition and a second entity different from the first entity; and
in response to detecting the concurrent usage conflict, updating conflict data to include an indication of the concurrent usage conflict associated with the first entity and the first partition.

2. The method of claim 1, wherein:
the usage information comprises geospatial information indicative of a location associated with the first entity in a geographic coordinate system; and
mapping the usage information comprises mapping the location in the geographic coordinate system to the first partition encompassing the location.

3. The method of claim 1, wherein:
the usage information comprises data indicative of an anticipated operating state of the first entity in the future; and
mapping the usage information comprises:
determining an anticipated location of the first entity based at least in part on the anticipated operating state; and
mapping the anticipated location to the first partition of the plurality of partitions, wherein the first partition encompasses the anticipated location.

4. The method of claim 1, wherein mapping the usage information comprises converting the usage information defining the operating region in a spatial reference domain from the spatial reference domain to the one or more partitions in a partitioned domain comprising the plurality of partitions corresponding to the volume of navigable space.

5. The method of claim 1, wherein the registered usage data associated with the first partition comprises first indicia of the first entity and a first time period associated with the first entity and second indicia of the second entity and a second time period associated with the second entity, wherein detecting the concurrent usage conflict comprises:
identifying a spatial conflict between the first entity and the second entity associated with the first partition based on the registered usage data associated with the first partition including the first indicia of the first entity and the second indicia of the second entity;
after identifying the spatial conflict, identifying a temporal conflict between the first entity and the second entity associated with the first partition when the first time period and the second time period overlap; and
detecting the concurrent usage conflict when the spatial conflict and the temporal conflict associated with the first partition concurrently exist between the first entity and the second entity.

6. The method of claim 1, further comprising, after updating the conflict data:
analyzing subscription data using an identifier associated with the first partition to identify a subscribing client subscribed to monitoring the first partition in response to updating the conflict data; and
providing notification of the concurrent usage conflict associated with the first entity and the first partition to the subscribing client in response to identifying the subscribing client associated with the first partition based on the subscription data.

7. The method of claim 1, further comprising determining anticipated usage information corresponding to an anticipated operating region for the first entity in the future based at least in part on the usage information, wherein:
mapping the usage information comprises mapping the anticipated usage information to the first partition encompassing the anticipated operating region; and
updating the registered usage data comprises updating the registered usage data to maintain the association between the first partition and the first entity.

8. A computer-readable medium having computer-executable instructions stored thereon that, when executed by a processing system, cause the processing system to:
obtain, from a client over a network, usage information associated with a first entity, wherein the usage information is indicative of an operating region for the first entity within a volume of navigable space;
map the usage information to one or more partitions of a plurality of partitions corresponding to the volume of navigable space, wherein the one or more partitions encompass the operating region for the first entity;
update registered usage data associated with the one or more partitions to maintain an association between the one or more partitions and the first entity;
detect a concurrent usage conflict associated with a first partition of the one or more partitions after updating the registered usage data associated with the first partition based at least in part on a second association between the first partition and a second entity different from the first entity; and
in response to detecting the concurrent usage conflict, update conflict data to include an indication of the concurrent usage conflict associated with the first entity and the first partition.

9. The computer-readable medium of claim 8, the usage information comprising geospatial information indicative of a location associated with the first entity in a geographic coordinate system, wherein the computer-executable instructions are configurable to cause the processing system to map the location in the geographic coordinate system to the first partition encompassing the location.

10. The computer-readable medium of claim 8, the usage information comprising data indicative of an anticipated operating state of the first entity, wherein the computer-executable instructions are configurable to cause the processing system to:
determine an anticipated location of the first entity based at least in part on the anticipated operating state; and
map the anticipated location to the first partition of the plurality of partitions, wherein the first partition encompasses the anticipated location.

11. The computer-readable medium of claim 8, wherein the computer-executable instructions are configurable to cause the processing system to convert the usage information defining the operating region in a spatial reference domain from the spatial reference domain to the one or more partitions in a partitioned domain comprising the plurality of partitions corresponding to the volume of navigable space.

12. The computer-readable medium of claim 8, wherein the registered usage data associated with the first partition comprises first indicia of the first entity and a first time period associated with the first entity and second indicia of the second entity and a second time period associated with the second entity, wherein the computer-executable instructions are configurable to cause the processing system to:
identify a spatial conflict between the first entity and the second entity associated with the first partition based on the registered usage data associated with the first partition including the first indicia of the first entity and the second indicia of the second entity;
after identifying the spatial conflict, identify a temporal conflict between the first entity and the second entity associated with the first partition when the first time period and the second time period overlap; and
detect the concurrent usage conflict when the spatial conflict and the temporal conflict associated with the first partition concurrently exist between the first entity and the second entity.

13. The computer-readable medium of claim 8, wherein the computer-executable instructions are configurable to cause the processing system to:
analyze subscription data using an identifier associated with the first partition to identify a subscribing client subscribed to monitoring the first partition in response to updating the conflict data; and
provide notification of the concurrent usage conflict associated with the first entity and the first partition to the subscribing client in response to identifying the subscribing client associated with the first partition based on the subscription data.

14. The computer-readable medium of claim 8, wherein the computer-executable instructions are configurable to cause the processing system to determine anticipated usage information corresponding to an anticipated operating region for the first entity based at least in part on the usage information, wherein:
mapping the usage information comprises mapping the anticipated usage information to the first partition encompassing the anticipated operating region; and
updating the registered usage data comprises updating the registered usage data to maintain the association between the first partition and the first entity.

15. A system comprising:
a database to maintain registered airspace usage data and conflict data for a volume of navigable airspace; and
a conflict management server coupled to the database and a communications network to provide an airspace management service configurable to:
receive, from a client over the communications network, a reservation request comprising airspace usage information associated with a first entity, wherein the airspace usage information is indicative of an operating region for the first entity within the volume of navigable airspace;
map the airspace usage information to one or more airspace partitions of a plurality of airspace partitions corresponding to the volume of navigable airspace, wherein the one or more airspace partitions encompass the operating region for the first entity;
update the registered airspace usage data associated with the one or more airspace partitions to maintain an association between the one or more airspace partitions and the first entity;
detect a concurrent usage conflict associated with a first airspace partition of the one or more airspace partitions after updating the registered airspace usage data associated with the first airspace partition based at least in part on a second association between the first airspace partition and a second entity different from the first entity; and
in response to detecting the concurrent usage conflict, update the conflict data to include an indication of the concurrent usage conflict associated with the first entity and the first airspace partition.

16. The system of claim 15, wherein the database comprises subscription data including a subscription associated with at least one of the first entity, the second entity and the first airspace partition, wherein the airspace management service is configurable to automatically identify the subscription matching the concurrent usage conflict after updating the conflict data and automatically provide a conflict notification over the communications network to a subscribed client associated with the subscription.

17. The system of claim 15, wherein:
the airspace usage information comprises geospatial information indicative of a location associated with the first entity in a geographic coordinate system; and
the airspace management service is configurable to convert the location from the geographic coordinate system to the first airspace partition encompassing the location.

18. The system of claim 15, wherein:
the airspace usage information comprises a flight plan indicative of a planned route for the first entity; and
the airspace management service is configurable to map the flight plan to the one or more airspace partitions encompassing the planned route for the first entity.

19. The system of claim 15, wherein:
the airspace usage information comprises data characterizing a current operating state of the first entity; and
the airspace management service is configurable to determine an anticipated location of the first entity in the future based at least in part on the data characterizing the current operating state and map the anticipated location to the first airspace partition encompassing the anticipated location.

20. The system of claim 15, wherein the plurality of airspace partitions comprise a plurality of substantially cubic partitions comprising respective discrete nonoverlapping portions of the volume of navigable airspace.
